(19) United States
(12) Patent Application Publication
(10) Pub. No.: US 2026/0249867 A1
(43) Pub. Date: Aug. 27, 2026

(54) VEHICLE

(71) Applicant: KAWASAKI MOTORS, LTD., Hyogo (JP)

(72) Inventors: Shohei TERAI, Hyogo (JP); Kouji ITO, Hyogo (JP); Osamu TANI, Hyogo (JP); Takenori SEGAWA, Hyogo (JP); Yoshiki HISAMOTO, Hyogo (JP)

(73) Assignee: KAWASAKI MOTORS, LTD., Hyogo (JP)

(21) Appl. No.: 19/541,443

(22) Filed: Feb. 17, 2026

Related U.S. Application Data
(60) Provisional application No. 63/761,319, filed on Feb. 21, 2025.

(51) Int. Cl. B60W 50/08; B60W 10/20; B60W 30/06; B60W 30/09; B60W 30/182; B60W 50/14; B60W 60/00

(52) U.S. Cl. CPC B60W 50/082; B60W 10/20; B60W 30/06; B60W 30/09; B60W 30/182; B60W 50/14; B60W 60/0053; B60W 2420/403

(57) ABSTRACT

A vehicle includes a traveling device that causes the vehicle to travel, an operation device, a sensor, and a controller. The operation device receives an input operation by a driver. The operation device includes a driving operation device for the driver to perform a driving operation of the vehicle. The sensor detects vehicle information relating to behavior of the vehicle, and road surface information relating to a road surface along which the vehicle is to travel. The controller acquires operation information relating to the input operation and detection information detected by the sensor. The vehicle travels while switching an operation mode of the vehicle between a manual operation mode in which the traveling device operates based on the driving operation with respect to the driving operation device, and an automatic operation mode in which the traveling device operates based on travel commands from the controller.

### CROSS-REFERENCE TO RELATED APPLICATION

This application claims the benefit of priority to US Provisional Application No. 63/761,319 filed on Feb. 21, 2025, the entire contents of which are incorporated by reference herein.

### TECHNICAL FIELD

The present disclosure relates to a vehicle.

### BACKGROUND OF THE INVENTION

In JP 2020-013379 A, a vehicle is disclosed that includes a controller capable of causing the vehicle to travel autonomously.

### SUMMARY OF THE INVENTION

According to a first aspect of the present disclosure, a vehicle is provided. The vehicle is an off-road vehicle configured to travel over rough terrain. The vehicle includes a traveling device configured to cause the vehicle to travel, an operation device, a sensor unit, and a controller. The operation device is configured to receive an input operation by a driver. The operation device includes a driving operation device for the driver to perform a driving operation of the vehicle. The sensor unit is configured to detect vehicle information relating to behavior of the vehicle, and road surface information relating to a road surface along which the vehicle is to travel. The controller is configured to acquire operation information relating to the input operation and detection information detected by the sensor unit. The vehicle is configured to travel while switching an operation mode of the vehicle between a manual operation mode in which the traveling device operates based on the driving operation with respect to the driving operation device, and an automatic operation mode in which the traveling device operates based on travel commands from the controller. The controller is configured to switch the operation mode from the automatic operation mode to the manual operation mode when the operation mode is the automatic operation mode and at least one of the acquired operation information or the detection information satisfies a switching condition.

According to this aspect, it is possible to provide a vehicle that can respond rapidly even in exceptional circumstances during autonomous travel in the automatic operation mode.

### BRIEF DESCRIPTION OF DRAWINGS

FIG. 1 is a schematic configuration view of a vehicle.

FIG. 2 is a system configuration view of the vehicle.

FIG. 3 is a flowchart showing an example of route planning processing.

FIG. 4 is a flowchart showing an example of switching processing.

### DETAILED DESCRIPTION OF THE INVENTION

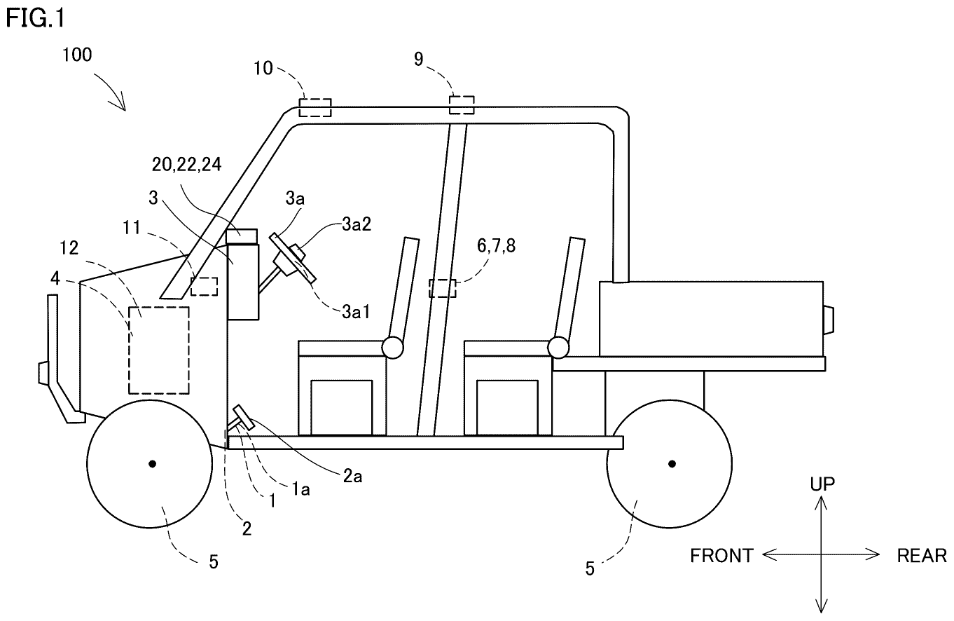

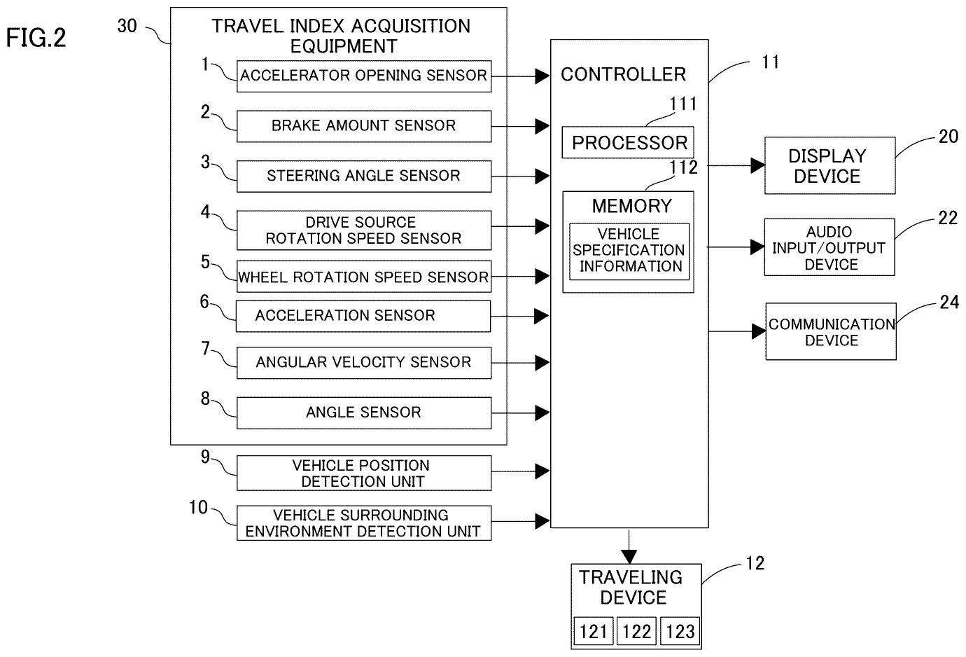

FIG. 1 is a schematic configuration view of a vehicle 100 according to an embodiment of the present disclosure. FIG. 2 is a schematic system configuration view of the vehicle 100. The vehicle 100 according to the present embodiment includes a rollover protective structure (ROPS) and is an off-road vehicle that travels over rough terrain. The vehicle 100 is configured to travel on terrain that is not paved, such as earth, mud, rocks and the like in a desert or a forest, for example. Hereinafter, the configuration of the vehicle 100 will be described with reference to FIG. 1 and FIG. 2. In each of the drawings, the vehicle 100 is exemplified by a configuration to which reference signs are allocated. An arrangement and size of each of the configurations (each of components) in the drawings do not represent an accurate arrangement and size.

The vehicle 100 is configured to travel in an automatic operation mode and a manual operation mode. The automatic operation mode is an operation mode in which the vehicle 100 travels autonomously along a planned route. In the automatic operation mode, the vehicle 100 travels regardless of an operation by a driver of an accelerator pedal 1a, a brake pedal 2a, and a steering wheel 3a, which are driving operation devices. In the manual operation mode, the vehicle 100 travels in accordance with the operation of the driving operation devices by the driver. In the present disclosure, the driver can also be referred to as an occupant, as appropriate.

The vehicle 100 includes a traveling device 12, travel index acquisition equipment 30, a vehicle position detection unit 9, a vehicle surrounding environment detection unit 10, a controller 11, a display device 20, an audio input/output device 22, and a communication device 24.

The traveling device 12 includes a drive device 121, a braking device 122, and a steering device 123. The drive device 121 is a device configured to output a drive force to be imparted to the vehicle 100, in order to cause the vehicle 100 to travel. The drive device 121 is, for example, an internal combustion engine, a motor, or the like. The braking device 122 is a device configured to output a braking force to be imparted to the vehicle 100, in order to brake the vehicle 100. The braking device 122 is a brake device, for example. The steering device 123 is a device configured to output a steering force to be imparted to the vehicle 100, in order to steer the vehicle 100. The steering device 123 is a steering device, for example. In the manual operation mode, the drive device 121, the braking device 122, and the steering device 123 respectively operate in accordance with operation of the accelerator pedal 1a, the brake pedal 2a, and the steering wheel 3a. In the automatic operation mode, the drive device 121, the braking device 122, and the steering device 123 respectively operate in accordance with travel commands output from the controller 11, regardless of the operation of the accelerator pedal 1a, the brake pedal 2a, and the steering wheel 3a.

The travel index acquisition equipment 30 detects information indicating a travel state of the vehicle 100 (behavior of the vehicle 100). As shown in FIG. 2, for example, the travel index acquisition equipment 30 includes an accelerator opening sensor 1, a brake amount sensor 2, a steering angle sensor 3, a drive source rotation speed sensor 4, a wheel rotation speed sensor 5, an acceleration sensor 6, an angular velocity sensor 7, and an angle sensor 8.

The accelerator opening sensor 1 detects an operation amount of the accelerator pedal 1a. The brake amount sensor 2 detects an operation amount of the brake pedal 2a. The steering angle sensor 3 detects an operation direction and an operation amount of the steering wheel 3a, by detecting a steering angle of the steering wheel 3a.

The drive source rotation speed sensor 4 detects a rotation speed of an output shaft of a drive source. The wheel rotation speed sensor 5 detects a rotation speed of a drive wheel. The wheel rotation speed sensor 5 may detect a rotation speed of non-driven wheels. The acceleration sensor 6 is an inertial sensor, and detects an external force acting on the vehicle 100. The angular velocity sensor 7 detects a wheel angular velocity. The angle sensor 8 is a gyro sensor, and detects a posture of the vehicle 100. The vehicle 100 may further include various sensors, such as a stroke sensor provided on a suspension or the like. The posture of the vehicle 100 may be estimated from a degree of acceleration obtained by performing an arithmetic operation on an expansion/contraction amount of the stroke sensor provided on the suspension and a detection result of the stroke sensor.

The vehicle position detection unit 9 (the vehicle position detector) is configured to detect the position of the vehicle 100. The position of the vehicle 100 can also be said to be a vehicle position, or a self-position. In the present embodiment, the vehicle position detection unit 9 includes a global navigation satellite system (GNSS). The vehicle position detection unit 9 may output, as the vehicle position, a position obtained by performing an arithmetic operation on detection results of a wheel velocity sensor, an inertial sensor, and the like. In addition to or in place of the GNSS, the vehicle position detection unit 9 may acquire position information of the vehicle 100 from a ground base station, via the communication device 24.

The vehicle surrounding environment detection unit 10 detects a route on which the vehicle 100 is to travel, and a situation surrounding the vehicle 100. The vehicle surrounding environment detection unit 10 includes a camera, for example. In addition to the camera, the vehicle surrounding environment detection unit 10 may include a distance sensor that uses radar, laser, infrared, sound waves, or the like.

The vehicle surrounding environment detection unit 10 includes a sensor that is able to detect irregularities and an inclination (gradient, ups and downs) of a road surface. Of the irregularities of the road surface, the vehicle surrounding environment detection unit 10 is preferably configured to detect a protrusion having a width smaller than a vehicle width of the vehicle 100, and a recess (depression) having a width smaller than the vehicle width of the vehicle 100. Of the irregularities of the road surface, the protrusion having the width smaller than the vehicle width of the vehicle 100 will also be referred to as a road surface protrusion. Of the irregularities of the road surface, the recess having the width smaller than the vehicle width of the vehicle 100 will also be referred to as a road surface recess. The road surface protrusion may be a fallen tree or a fallen rock, for example. The road surface recess may be a crevice, a ditch, or a rut, for example.

The vehicle surrounding environment detection unit 10 is configured to determine whether or not a height of the road surface protrusion is higher than a ground clearance of the vehicle 100. The ground clearance is a height of a bottom surface of the vehicle 100 from a ground contact surface of the tires of the vehicle 100. The vehicle surrounding environment detection unit 10 is preferably configured to detect a road width of the road surface that can be traveled on. The recognition of the road surface protrusions and the road surface recesses in the vehicle surrounding environment detection unit 10 may be realized by a learning arithmetic operation using image processing.

The communication device 24 communicates with the outside of the vehicle 100 via a public network or the like. The communication with the outside of the vehicle 100 includes a management center of the vehicle 100, or a server device provided at a position separated from the vehicle 100. The communication device 24 need not necessarily be installed in the vehicle 100. The communication device 24 may be provided in a mobile device, such as a smartphone or a tablet terminal carried by the driver. The controller 11 may communicate with the outside of the vehicle 100 via the mobile device.

The display device 20 includes a display of an instrument panel or a navigation device, for example. The audio input/output device 22 includes a microphone and a speaker, for example. The vehicle 100 can perform notification of various information, such as the travel state of the vehicle 100, a warning, or the like, via the display device 20 and the audio input/output device 22, or the like. The vehicle 100 is configured to allow the driver to input various information relating to route planning, such as the current position, the target location, or the like, via the display device 20 and the audio input/output device 22, or the like. The vehicle 100 may be configured to allow, via the display device 20 and the audio input/output device 22, selection of the operation mode of the vehicle 100, or the input of information relating to settings and the like of conditions in switching processing to be described later.

As shown in FIG. 1, the vehicle 100 further includes a grip sensor 3a1, and a sound alarm 3a2. The grip sensor 3a1 is provided at the steering wheel 3a, and detects a gripping force of the driver with respect to the steering wheel 3a. The sound alarm 3a2 is a device for promoting attention to the surroundings of the vehicle 100, and is provided at the steering wheel 3a. The sound alarm 3a2 generates sound by being pressed by the driver, for example.

The controller 11 includes a processor 111 and a memory 112. The controller 11 is configured to transmit and receive signals with each of the components of the vehicle 100. Detection results (signals) of the travel index acquisition equipment 30, the vehicle position detection unit 9, and the vehicle surrounding environment detection unit 10 are input to the controller 11, for example. Further, various signals are input to the controller 11, for example, from the display device 20, the audio input/output device 22, the grip sensor 3a1, and the sound alarm 3a2.

In the present embodiment, the controller 11 is configured to acquire operation information and detection information.

The operation information is information relating to input operations to the vehicle 100 by the driver. The input operations include operations of the brake pedal 2a and the steering wheel 3a as the driving operation devices. For example, the controller 11 may acquire, as the operation information, the detection results of the brake amount sensor 2 and the steering angle sensor 3 in the travel index acquisition equipment 30. Further, for example, the controller 11 may acquire detection results of the grip sensor 3a1 and operation of the sound alarm 3a2 as the operation information.

In the present embodiment, the detection information includes vehicle information and road surface information. The vehicle information is information relating to the behavior of the vehicle 100. The vehicle information may include a vehicle position, a vehicle speed, an acceleration, a posture, and information relating to the vehicle 100 being stuck. For example, the controller 11 may acquire, as the vehicle information, the detection results of the vehicle position detection unit 9, and the detection results of the various sensors in the travel index acquisition equipment 30 (the drive source rotation speed sensor 4, the wheel rotation speed sensor 5, the acceleration sensor 6, the angular velocity sensor 7, the angle sensor 8, for example), or may acquire, as the vehicle information, information calculated by performing arithmetic processing on these detection results.

The road surface information is information relating to the road surface along which the vehicle 100 travels. The road surface information can be said to be environment information relating to the surrounding environment of the vehicle 100. The road surface information may include information relating to at least one of an obstacle, unevenness of the road surface, muddiness of the road surface, and a road width, in a traveling direction of the vehicle 100. For example, the controller 11 may acquire the detection results of the vehicle surrounding environment detection unit 10 as the road surface information, or may acquire information calculated by performing arithmetic processing on these detection results, as the road surface information.

The controller 11 outputs various commands (signals) that cause the vehicle 100 to travel autonomously to the drive device 121, the brake device 122, and the steering device 123 of the traveling device 12, and causes the vehicle 100 to travel autonomously by controlling these devices. The commands output from the controller 11 to the traveling device 12 will also be referred to as travel commands and autonomous commands. Further, the controller 11 can acquire various information from the display device 20 and the audio input/output device 22, and can output various information to the display device 20 and the audio input/output device 22.

The controller 11 can execute various processing. For example, the controller 11 decides (generates) the travel plan of the vehicle 100. The controller 11 controls the traveling device 12 such that the vehicle 100 travels autonomously in accordance with the decided travel plan. The travel plan includes the route from a departure location (current position) to the target location, and travel conditions, such as the vehicle speed, a drive state, and the like of the vehicle 100. The travel plan will also be referred to as a route plan or the route planning.

Various processing includes the switching processing. The switching processing is processing to switch the operation mode to the manual operation mode, in a predetermined situation, when the operation mode of the vehicle 100 is the automatic operation mode. The predetermined situation may be a situation in which the vehicle 100 is assumed to be in exceptional circumstances. The exceptional circumstances can also be referred to as a special situation, such as a situation in which temporary or limited measures are necessary.

The controller 11 can accelerate and decelerate the vehicle 100, can steer the vehicle 100, and can execute the switching of the drive state of the vehicle 100, and the like by controlling the various components of the vehicle 100. The switching of the drive state includes switching the vehicle 100 between two-wheel drive and four-wheel drive, switching between a differential-free state and a differential-lock state, changing a gear ratio, switching between a forward movement state and a reverse movement state, and the like.

The controller 11 may decide (generate) the travel plan before the travel of the vehicle 100, may generate the travel plan during the travel of the vehicle 100, or may change the decided travel plan, as needed, during the travel of the vehicle 100. The changing of the travel plan may include traveling a detour route that makes a detour from the departure location to the target location, changing (suppressing) a decided travel speed, or the like.

Vehicle specification information that is information indicating the vehicle class or performance of the vehicle 100 is stored in advance in the memory 112. The vehicle specification information includes various information relating to the vehicle 100, such as a total length, a total width, a wheel diameter, a wheelbase, and a designed minimum turning radius of the vehicle 100, and the like, for example.

Map information may be further stored in the memory 112. The map information may be acquired from outside via the communication device 24. The map information preferably includes information relating to the ups and downs and inclination of the road surface, and information that can be detected by the vehicle surrounding environment detection unit 10. The controller 11 may update the map information based on information and the like provided from one or more vehicles around the vehicle 100 and acquired by the communication device 24.

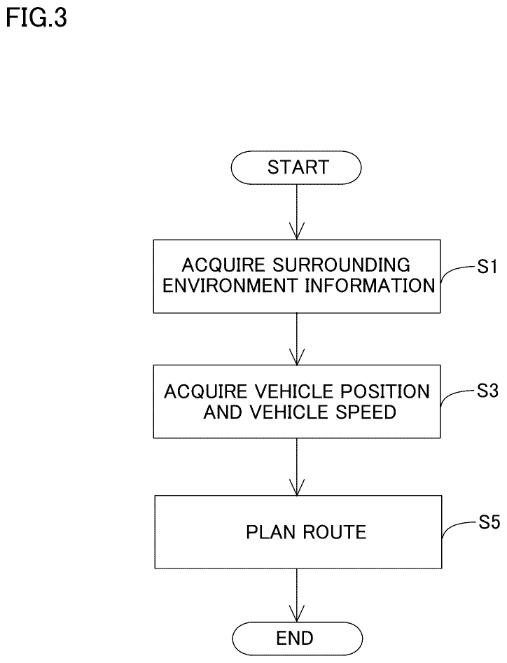

FIG. 3 is a flowchart showing an example of route planning processing executed by the processor 111 of the controller 11. The route planning processing is executed when the operation mode of the vehicle 100 is the automatic operation mode, for example. For example, at a predetermined interval, the processor 111 of the controller 11 generates (decides) the travel plan, which includes a departure position, the route from the current position to the target location, and the travel conditions such as the speed and drive state of the vehicle 100, and causes the vehicle 100 to travel autonomously based on the decided travel plan. Note that causing the vehicle 100 to travel autonomously based on the travel plan (the route) may mean causing the vehicle 100 to travel along the route, or may mean that the processor 111 amends (corrects, changes) the route in the travel plan, in accordance with the road surface situation or the like.

At step S1, the processor 111 acquires surrounding environment information of the vehicle 100, via the vehicle surrounding environment detection unit 10.

At step S3, the processor 111 acquires the vehicle position and the vehicle speed.

At step S5, the controller 11 generates the travel plan, which includes the route and the travel conditions, based on the information acquired at step S1 and step S3. The controller 11 controls the traveling device 12 such that the vehicle 100 travels autonomously in accordance with the travel plan.

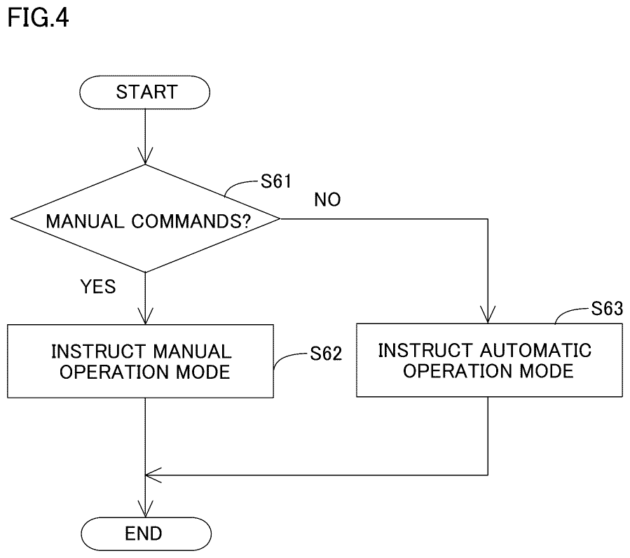

FIG. 4 is a flowchart showing an example of the switching processing. The switching processing is executed by the processor 111 of the controller 11 when the operation mode of the vehicle 100 is the automatic operation mode.

For example, at step S61, the processor 111 determines whether or not the vehicle 100 is to be caused to travel based on manual commands. The vehicle 100 is to be caused to travel based on the manual commands means that the operation mode of the vehicle 100 is to be the manual operation mode. In the present embodiment, the processor 111 acquires the above-described operation information and detection information, and determines whether or not the vehicle 100 is to be caused to travel based on the manual command, based on at least one of the acquired operation information or the detection information. For example, when information that is based on at least one of the operation information or the detection information satisfies a predetermined switching condition, the processor 111 makes a positive determination at step S61. The operation information, detection information, and switching condition at step S61 will be described in detail below.

When the processor 111 determines that the vehicle 100 is to be caused to travel based on the manual commands (yes at step S61), the processor 111 advances the processing to step S62. At step S62, the processor 111 switches the operation mode of the vehicle 100 from the automatic operation mode to the manual operation mode. For example, the processor 111 stops the autonomous commands to the traveling device 12, and operates the traveling device 12 using commands (manual commands) via the driving operation devices. In this way, the vehicle 100 travels in the manual operation mode.

On the other hand, when the processor 111 determines that the vehicle 100 is not to be caused to travel based on the manual commands (no at step S61), the processor 111 advances the processing to step S63, and continues to output the autonomous commands to the traveling device 12. In this way, the vehicle 100 continues to travel in the automatic operation mode.

Hereinafter, the operation information, the detection information, and the switching condition used at step S61 in the switching processing will be exemplified. In the present disclosure, including the claims, the expression “at least one of A or B” means any one or both of A and B. That is, it encompasses (i) a case in which only A is satisfied, (ii) a case in which only B is satisfied, and (iii) a case in which both A and B are satisfied.

For example, the switching condition may include at least one of (i) an operation amount of the brake pedal 2a that is equal to or greater than a predetermined operation amount as the operation information, or (ii) an operation amount of the steering wheel 3a that is equal to or greater than a predetermined steering amount as the operation information. In a state in which the vehicle 100 is traveling autonomously, a possibility is conceivable that the vehicle 100 is in the exceptional circumstances when a sudden brake operation or steering operation by the driver has been performed.

For example, the switching condition may include, as the operation information, at least one of an input to the sound alarm 3a2, an input to the grip sensor 3a1, or an input to the audio input/output device 22 being performed. When the input has been performed to the sound alarm 3a2, the grip sensor 3a1, or the audio input/output device 22, the possibility is conceivable that the vehicle 100 is in the exceptional circumstances. Note, for example, that the switching condition may include a detection value of the grip sensor 3a1 being equal to or greater than a predetermined value. When the driver has strongly gripped the steering wheel 3a to a degree equal to or greater than the predetermined value, the possibility is conceivable that the vehicle 100 is in the exceptional circumstances.

For example, the vehicle information may include at least one of the speed of the vehicle 100 or information relating to the vehicle 100 being stuck. The switching condition may include a case in which the speed of the vehicle 100 is equal to or greater than a predetermined speed, or a case in which there is a possibility that the vehicle 100 is stuck. Further, for example, the above-described switching condition may be made less stringent based on these pieces of vehicle information. Making the switching condition less stringent also means switching from the automatic operation mode to the manual operation mode more quickly, or making the transition to the manual operation mode easier.

For example, the road surface information may include at least one of an obstacle in the surroundings of the vehicle 100, unevenness of the road surface, muddiness, and the road width. The switching condition may include at least one of there is an obstacle in the surroundings of the vehicle 100, protrusions are present in the road surface, recesses are present in the road surface, or the road surface is muddy. Further, the above-described switching condition may be made less stringent based on these pieces of road surface information.

For example, the switching condition may include a case in which the vehicle 100 is traveling while a position (ground contact position) in the up-down direction of at least one of the plurality of wheels of the vehicle 100 changes from the position in the up-down direction of the other wheels, by an amount equal to or greater than a predetermined value. The processor 111 may determine that this type of travel has been performed based on the vehicle information and the road surface information.

For example, the switching condition may include that the vehicle 100 is in a displacement state, which is at least one of a state of the vehicle 100 being displaced by an amount equal to or greater than a predetermined angle around a vehicle front-rear axis, being displaced by an amount equal to or greater than a predetermined angular velocity, or being displaced by an amount equal to or greater than a predetermined angular acceleration. The processor 111 may determine the displacement state of the vehicle 100 based on at least one of the vehicle information or the road surface information.

For example, the switching condition may be that the vehicle 100 has entered a predetermined travel region. The predetermined travel region may be stored as map information in the memory 112 of the controller 11. The processor 111 may determine whether or not the vehicle 100 has entered the travel region based on the position information acquired from the vehicle position detection unit 9, for example.

As described above, in the present embodiment, the controller 11 (the processor 111) determines the possibility that the vehicle 100 is in the exceptional circumstances based on at least one of the acquired operation information or detection information, and switches the operation mode of the vehicle 100 from the automatic operation mode to the manual operation mode. Thus, according to this aspect, the driver can achieve a rapid response in the exceptional circumstances.

The following modifications can be further made to the above-described embodiment.

A configuration may be adopted in which the switching condition for executing the switching processing can be set by the driver. For example, the processor 111 (the controller 11) may be configured to receive an input of a setting for the switching condition, via the display device 20, the audio input/output device 22, or the like. The processor 111 may output, via the display device 20, the audio input/output device 22, or the like, information prompting the setting input of the switching condition. The processor 111 may execute the switching processing using the set switching condition. According to this mode, the driver can set the switching condition to the manual operation mode as desired. Thus, the vehicle 100 can be provided that offers improved convenience.

When the processor 111 has made the positive determination at step S61, the processor 111 may notify the driver, via a notification unit (notification device) of information indicating that the operation mode of the vehicle 100 has been switched to the manual operation mode. The display device 20 and the audio input/output device 22 may function as the notification unit, or an output device other than these may function as the notification unit. According to this mode, the driver can ascertain the current operation mode of the vehicle 100.

The vehicle 100 may include a setting release unit, operated by the driver, for releasing the manual operation mode. The processor 111 may be configured to switch the operation mode to the automatic operation mode when the processor 111 has accepted that the setting release unit has been operated while the operation mode is the manual operation mode. The display device 20 and the audio input/output device 22 may function as the setting release unit, or an input device other than these may function as the setting release unit. According to this mode, the driver can restore the vehicle 100 to the automatic operation mode in any given situation.

When the processor 111 switches the operation mode of the vehicle 100 from the automatic operation mode to the manual operation mode using the switching processing, the processor 111 may transmit at least one of the vehicle information or the road surface information to an external device via the communication device 24. The external device may be a management center of the vehicle 100 or a server device provided at a position separated from the vehicle 100. The information to be transmitted may be information used in the determination at step S62, or may be information when the determination has been executed. According to this mode, data management and analysis can be performed using data (the information) transmitted to the external device when the switching of the operation mode has been performed, such as in the exceptional circumstances or the like.

In the above-described switching processing and route planning processing, the controller 11 acquires the vehicle information and the road surface information (detection information) at a predetermined cycle from the travel index acquisition equipment 30, the vehicle position detection unit 9, and the vehicle surrounding environment detection unit 10. The controller 11 may make the positive determination at step S62 and switch the operation mode to the manual operation mode when an acquisition frequency of the detection information has decreased, when an acquired information amount has decreased, or the like. When the information acquired from the various sensors of the travel index acquisition equipment 30, the vehicle position detection unit 9, and the vehicle surrounding environment detection unit 10 decreases, there is a possibility that the vehicle 100 is in the exceptional circumstances. According to this mode, a rapid response can be made even in the exceptional circumstances.

A correspondence between each of structural elements (features) of the above-described embodiment and each of structural elements (features) of the present disclosure is as described below. Each of the structural elements of the embodiment is merely an example, and is not intended to limit each of the structural elements of the present disclosure. The vehicle 100 is an example of a “vehicle”. The controller 11 and the processor 111 are an example of a “controller”. The traveling device 12 is an example of a “traveling device”. The accelerator pedal 1a, the brake pedal 2a, and the steering wheel 3a are an example of a “driving operation device”. The accelerator pedal 1a, the brake pedal 2a, the steering wheel 3a, the grip sensor 3a1, the sound alarm 3a2, and the audio input/output device 22 are an example of an “operation device”. The travel index acquisition equipment 30, the vehicle position detection unit 9, and the vehicle surrounding environment detection unit 10 are an example of a “sensor unit”. A detection value of the brake amount sensor 2 is an example of “information relating to operation of a brake pedal”, and an “operation amount of the brake pedal”. A detection value of the steering angle sensor 3 is an example of “information relating to operation of a steering wheel”, and a “steering amount of the steering wheel”. The display device 20 and the audio input/output device 22 are an example of a “notification unit”. The display device 20 and the audio input/output device 22 are an example of a “condition setting unit”. The display device 20 and the audio input/output device 22 are an example of a “setting release unit”. The communication device 24 is an example of a “communication device”. A speaker included in the audio input/output device 22 is an example of an “audio output device”, and the audio input/output device 22 is an example of an “audio input device”.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality. There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer readable storage medium, a computer program product, a memory device, a record medium such as a CD-ROM or DVD, and/or the memory of a FPGAs or ASICs.

The present disclosure is not limited to the above-described embodiment and modified examples, and can be realized by various other aspects insofar as these do not depart from the gist and scope thereof. For example, the present disclosure can be realized by the following aspects. Each of technical features in the above-described embodiment and modified examples corresponding to technical features of each of the aspects described below can be switched or combined, as appropriate, in order to solve some or all of the issues of the present disclosure, or to achieve some or all of the effects of the present disclosure. Further, insofar as these technical features are not described as essential in the present specification, they may be omitted as appropriate.

What is claimed is:

1. A vehicle comprising:
a traveling device configured to cause the vehicle to travel;
an operation device including a driving operation device for a driver to perform a driving operation of the vehicle, the operation device being configured to receive an input operation by the driver;
a sensor unit configured to detect vehicle information relating to behavior of the vehicle, and road surface information relating to a road surface along which the vehicle is to travel; and
a controller configured to acquire operation information relating to the input operation and detection information detected by the sensor unit, wherein the vehicle is an off-road vehicle configured to travel over rough terrain,
the vehicle is configured to travel while switching an operation mode of the vehicle between a manual operation mode in which the traveling device operates based on the driving operation with respect to the driving operation device, and an automatic operation mode in which the traveling device operates based on travel commands from the controller, and
the controller switches the operation mode from the automatic operation mode to the manual operation mode when the operation mode is the automatic operation mode and at least one of the acquired operation information or the detection information satisfies a switching condition.

2. The vehicle according to claim 1, wherein
the traveling device includes a brake device and a steering device,
the driving operation device includes a brake pedal and a steering wheel, and
the operation information includes at least one of information relating to an operation of the brake pedal or information relating to an operation of the steering wheel.

3. The vehicle according to claim 2, wherein
the operation information includes at least one of an operation amount of the brake pedal or a steering amount of the steering wheel, and
the switching condition includes at least one of the operation amount of the brake pedal being equal to or greater than a predetermined operation amount, or the steering amount of the steering wheel being equal to or greater than a predetermined steering amount.

4. The vehicle according to claim 2, wherein
the operation device includes at least one of a sound alarm at the steering wheel, a grip sensor at the steering wheel and configured to detect a grip force of the driver on the steering wheel, and an audio input device configured to receive an input of voice, and
the operation information includes at least one of an input to the sound alarm, an input to the grip sensor, and an input to the audio input device.

5. The vehicle according to claim 4, wherein
the switching condition includes a detection value of the grip sensor being equal to or greater than a predetermined value.

6. The vehicle according to claim 1, wherein
the controller makes the switching condition less stringent, based on the detection information of the sensor unit.

7. The vehicle according to claim 1, wherein
the vehicle information includes at least one of a speed of the vehicle or information relating to the vehicle being stuck.

8. The vehicle according to claim 1, wherein
the road surface information includes information relating to at least one of an obstacle, unevenness of the road surface, muddiness of the road surface, and a road width, in a traveling direction of the vehicle.

9. The vehicle according to claim 1, comprising:
a notification unit configured to perform notification of information to the driver, wherein
the controller performs notification of the switching of the operation mode, via the notification unit, when the operation mode is switched from the automatic operation mode to the manual operation mode.

10. The vehicle according to claim 9, wherein
the notification unit includes at least one of an audio output device or a display device.

11. The vehicle according to claim 1, comprising:
a condition setting unit configured to receive a setting operation of the switching condition by the driver.

12. The vehicle according to claim 1, comprising:
a setting release unit operated by the driver, for releasing the manual operation mode, wherein
the controller switches the operation mode to the automatic operation mode when the operation mode is the manual operation mode and an operation of the setting release unit is received.

13. The vehicle according to claim 1, comprising:
a communication device configured to communicate with an external device outside the vehicle, wherein
via the communication device, the controller transmits at least one of the vehicle information or the road surface information to the external device when the operation mode is switched from the automatic operation mode to the manual operation mode.

14. The vehicle according to claim 1, wherein
the controller makes the switching condition less stringent when the controller determines, based on at least one of the vehicle information or the road surface information, that travel of the vehicle is travel in which, of a plurality of wheels provided in the vehicle, a position in the up-down direction of at least one of the wheels changes from a position of the other wheels in the up-down direction, by an amount equal to or greater than a predetermined amount.

15. The vehicle according to claim 1, wherein
when the controller is unable to acquire at least one of the vehicle information or the road surface information at a predetermined cycle, or when an acquired information amount decreases, the controller switches the operation mode from the automatic operation mode to the manual operation mode.

16. The vehicle according to claim 1, wherein
the switching condition includes the vehicle being in a displacement state, the displacement state being at least one of a state of the vehicle being displaced by an amount equal to or greater than a predetermined angle around a vehicle front-rear axis, being displaced by an amount equal to or greater than a predetermined angular velocity, or being displaced by an amount equal to or greater than a predetermined angular acceleration, and
the controller switches the operation mode from the automatic operation mode to the manual operation mode when the vehicle is in the displacement state, based on at least one of the vehicle information or the road surface information.

17. The vehicle according to claim 1, wherein
the sensor unit includes a vehicle position detection unit configured to detect position information of the vehicle, and
the controller switches the operation mode from the automatic operation mode to the manual operation mode when the vehicle enters a predetermined travel region.
